(19) United States
(12) Patent Application Publication
(10) Pub. No.: US 2006/0066805 A1
(43) Pub. Date: Mar. 30, 2006

(54) Liquid crystal on silicon (LCOS) microdisplay with retarder that reduces light beam polarization changes

(76) Inventors: Anders Grunnet-Jepsen, San Jose, CA (US); Chanda B. Walker, Houston, TX (US); Roland M. Morley, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/955,753

(22) Filed: Sep. 30, 2004

(51) Int. Cl. C09K 19/02

(52) U.S. Cl. 349/181

(57) ABSTRACT

According to embodiments of the present invention, a retarder for a liquid crystal on silicon microdisplay cell may include a twisted nematic cell sandwiched between index of refraction matching layers, isotropic material (for example, glass) disposed on the top and bottom index matching layers and antireflective material disposed on the top and bottom isotropic layers. In one embodiment, the retarder includes a fast axis oriented substantially ninety degrees out of phase relative to a fast axis of the residual retardance of the liquid crystal on silicon microdisplay cell.

### BACKGROUND

1. Field

Embodiments of the present invention relate to display devices and, in particular, to liquid crystal on silicon (LCOS)-based display devices.

2. Discussion of Related Art

Liquid crystal on silicon (LCOS)-based displays may be used in rear projection television, front projection television, and high-definition televisions, for example, to display video signals. Traditional liquid crystal on silicon (LCOS)-based displays have limitations, however.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a display system according to an embodiment of the present invention;

FIG. 2 is a cross sectional view of a retarder according to an embodiment of the present invention;

FIG. 3 is a cross sectional view of a retarder according to an alternative embodiment of the present invention;

FIG. 4 is a cross sectional view of a retarder according to an still another embodiment of the present invention;

FIG. 5 is a cross sectional view of a retarder according to an embodiment of the present invention;

FIG. 6 is a cross sectional view of a retarder according to an alternative embodiment of the present invention;

FIG. 7 is a high-level block diagram of a display system according to an alternative embodiment of the present invention;

FIG. 8 is a graphical representation showing a relationship between reflectivity of a retarder and contrast ratio of a display system according to an embodiment of the present invention; and

FIG. 9 is a flow chart illustrating operation of a display system according to an embodiment of the present invention.

### DETAILED DESCRIPTION OF THE ILLUSTRATED EMBODIMENTS

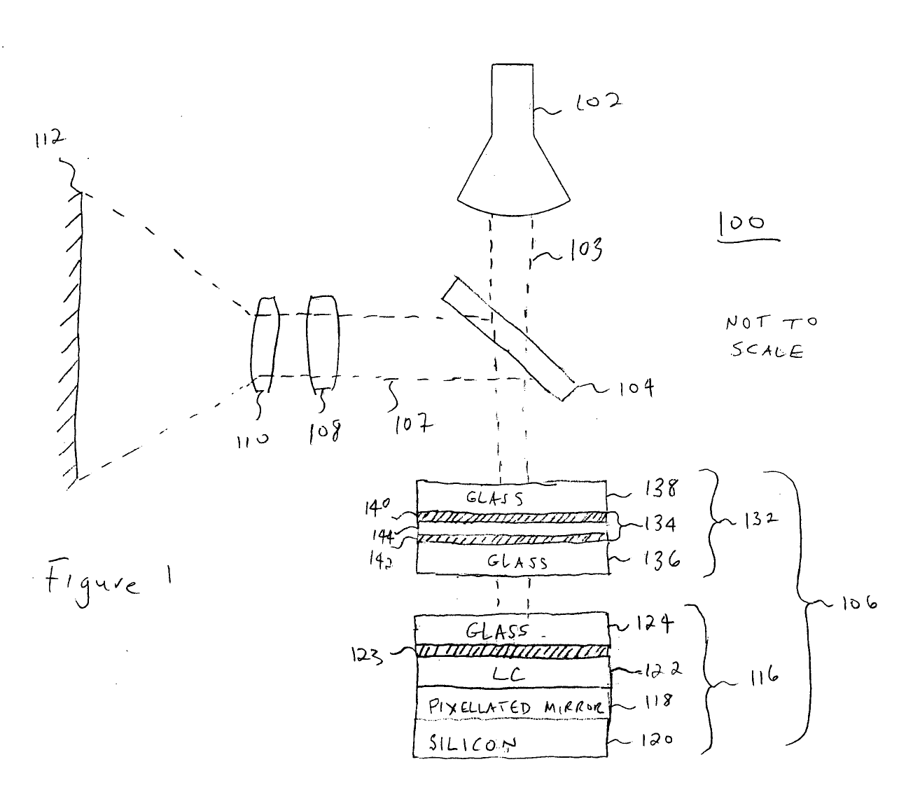

FIG. 1 is a high-level block diagram of a display system 100 according to an embodiment of the present invention. In the illustrated embodiment, the display system 100 includes a light source 102 operationally coupled to optics 104, such as a broadband or narrow band polarization beam splitter, for example (beam splitter 104). In the illustrated embodiment, the beam splitter 104 is operationally coupled to a light engine 106, to two lenses 108 and 110, and to a screen 112. In embodiments of the present invention, the display system 100 also may include other optics such as homogenizers, color wheels, filters (such as dielectric filters, ultraviolet filters, infrared filters, yellow notch filters, for example), polarization conversion systems, and the like. For purposes of clarity, the optics are not illustrated in the FIG. 1.

The example light source 102 may be any suitable light source that may emit a light beam 103 having a predetermined polarization state, such as horizontally polarized white light and/or vertically polarized white light, and or a combination thereof. In one embodiment, the light source 102 may include an ultra high-pressure lamp.

The example beam splitter 104 may be any suitable beam splitter that passes light of one polarization state to the light engine 106 and reflects light of orthogonal polarization to the screen 112 through the lenses 108 and 110. For example, the example beam splitter may pass horizontally polarized light to the light engine and reflect vertically polarized light to the screen 112. In one embodiment, light beam 107 may be light reflected by the beam splitter 104 to the screen 112.

The example lenses 108 and 110 may be any suitable optics that focuses light from the light beam 107 onto the screen 112.

The example screen 112 may be a rear projection television screen, a high-definition television screen, a front projection television screen, and/or any suitable screen that may be compatible with the light engine 106.

In the illustrated embodiment, the light engine 106 includes a liquid crystal on silicon (LCOS) microdisplay or cell 116, which includes a layer 118 of pixelated reflective material (for example, reflective material patterned into millions of pixels) disposed on a layer 120 of silicon. A layer 122 of liquid crystal may be disposed on the layer of pixelated reflective material 118. A layer 124 of isotropic material, such as, for example, glass, may be disposed on the liquid crystal layer 122. A layer 123 of transparent conducting material, such as indium tin oxide (ITO), for example, may be disposed between the layer 122 of liquid crystal and the isotropic material layer 124.

In embodiments of the present invention, the LCOS microdisplay 116 includes a fast axis and a slow axis. If the horizontal axis is the fast axis, then vertically polarized light traveling through the microdisplay 116 may be delayed with respect to horizontally polarized light traveling through LCOS microdisplay 116. Alternatively, if the vertical axis is the fast axis, then horizontally polarized light traveling through the LCOS microdisplay 116 may be delayed with respect to vertically polarized light traveling through LCOS microdisplay 116.

In one embodiment, in the absence of an applied electric field, the LCOS microdisplay 116 may behave like a half-wave plate and rotate light ninety degrees to an orthogonal polarization state. In an alternative embodiment, the LCOS microdisplay 116 includes a residual retardance or birefringence and if an electrical field is applied to the LCOS microdisplay 116, then the LCOS microdisplay 116 may rotate some of the light ninety degrees to an orthogonal polarization state and maintain most of the light in the original polarization state.

In the illustrated embodiment, the light engine 106 also includes a retarder or wave plate 132, which includes a layer 134 of birefringent material disposed between a layer 136 and a layer 138 of isotropic material. The illustrated retarder 132 includes top surface molecules 140, bottom surface molecules 142, and bulk molecules 144. Birefringent material suitable for implementing the birefringent material layer 134 in this embodiment may include a double refracting crystal such as, for example, a lithium niobate (LiNbO₃) crystal, a half-wave plate, a calcite crystal, a rutile crystal, a yttrium orthovanadate (YVO₄) crystal, a liquid crystal cell, a stretched polymer film, a stressed polymer film, or other suitable retarder.

In embodiments in which the birefringent material layer 134 may be a liquid crystal cell, the bottom surface of the isotropic material layer 138 may be rubbed (with a rabbit's foot, for example) in a manner to cause the molecules on the bottom surface of the isotropic material layer 138 to be oriented in a particular direction. The top surface of the isotropic material layer 136 also may be rubbed in a manner to cause the molecules on the top surface of the isotropic material layer 136 to be oriented in a particular direction. The isotropic material layers 136 and 138 may be sandwiched together and a bead of liquid crystal may be disposed between the isotropic material layers 136 and 138. A spacer may be used to define a space between the isotropic material layers 136 and 138. The top surface molecules 140 of the liquid crystal may align with the bottom surface molecules of the isotropic material layer 138 and the bottom surface molecules 142 of the liquid crystal may align with the top surface molecules of the isotropic material layer 136. The bulk molecules 144 may remain substantially unaligned with either the top or bottom surface molecules 140 or 142, respectively.

In one embodiment, the top surface molecules 140 and the bottom surface molecules 142 may be aligned perpendicular to the molecules of the isotropic material layer 138 and the isotropic material layer 136, respectively. In another embodiment, the top surface molecules 140 and the bottom surface molecules 142 may be aligned parallel to the molecules of the isotropic material layer 138 and the isotropic material layer 136, respectively. In still other embodiments, the top surface molecules 140 may be aligned perpendicular to the molecules of the isotropic material layer 138, the bottom surface molecules 142 may be aligned parallel to the molecules of the isotropic material layer 138, the top surface molecules 140 may be aligned parallel to the molecules of the isotropic material layer 138, or the bottom surface molecules 142 may be aligned perpendicular to the molecules of the isotropic material layer 138.

In one embodiment, the top surface molecules 140 may be aligned perpendicular to the polarization state of the incoming light beam 103. In one embodiment, the bottom surface molecules 142 may be aligned perpendicular to the polarization state of the reflected light beam.

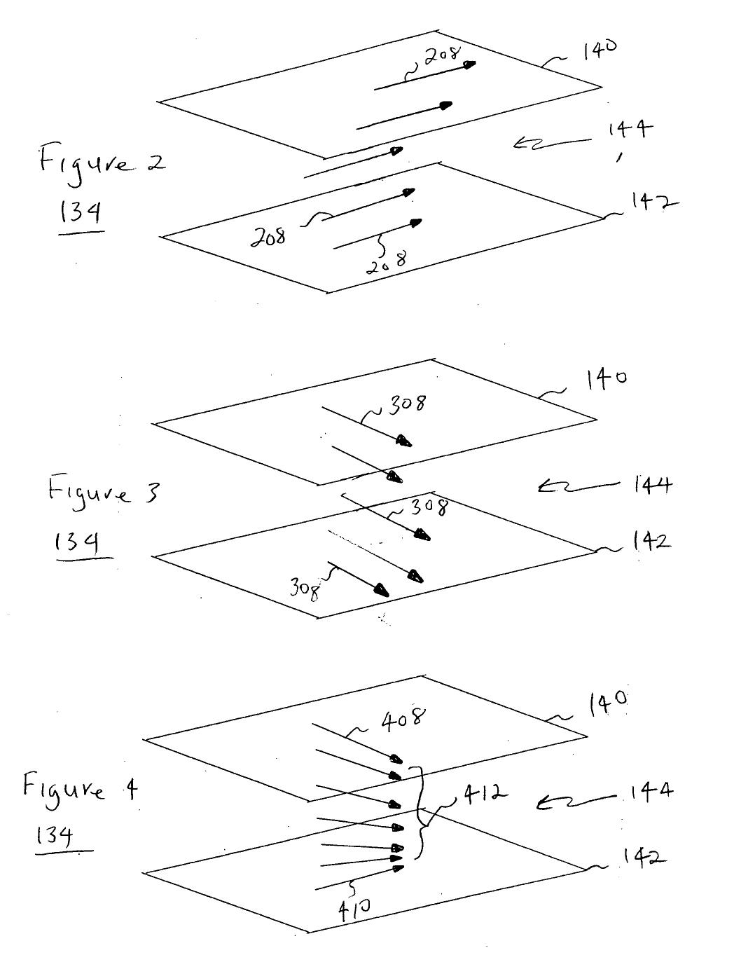

FIG. 2 is a cross sectional view of the birefringent material layer 134 according to an embodiment of the present invention. In the illustrated embodiment, the top surface molecules 140, bottom surface molecules 142, and bulk molecules 144 are oriented parallel to the surface of the birefringent material layer 134 and to each other, as indicated by the arrows 208.

FIG. 3 is a cross sectional view of the birefringent material layer 134 according to an alternative embodiment of the present invention. In the illustrated embodiment, the molecules 140, 142, and 144 are oriented perpendicular to the surface layer of the birefringent material layer 134 and parallel to each other in a direction indicated by the arrows 308.

FIG. 4 is a cross sectional view of the birefringent material layer 134 according to still another embodiment. In the illustrated embodiment, the top surface molecules 140 are oriented perpendicular to the surface of the birefringent material layer 134 as indicated by the arrow 408, the bottom surface molecules 142 are oriented parallel to the surface of the birefringent material layer 134 and perpendicular to the top surface molecules 140 as indicated by the arrow 410, and bulk molecules 144 are oriented in a chiral or helical direction as indicated by the arrows 412. In one embodiment, the birefringent material layer 134 may include a twisted nematic cell having a twist of ninety degrees.

In embodiments of the present invention, the retarder 132 includes a fast axis and a slow axis. If the horizontal axis is the fast axis, then vertically polarized light traveling through the retarder 132 may be delayed with respect to horizontally polarized light traveling through the retarder 132.

In embodiments of the present invention, the retarder 132 includes a fast index of refraction and a slow index of refraction. In one embodiment, if the horizontal index of refraction is the fast index of refraction, then vertically polarized light traveling through the retarder 132 may be delayed with respect to horizontally polarized light traveling through the retarder 132. For example, light having a polarization state that is perpendicular to the average direction of orientation of the molecules 140, 142, and 144 may see a fast index of refraction and light having a polarization state that is parallel to the average direction of orientation of the molecules 140, 142, and 144 may see a slow index of refraction.

In embodiments of the present invention, the difference between the fast index of refraction of the birefringent material layer 134 and the slow index of refraction may be the birefringence of the birefringent material layer 134 and the birefringence multiplied by the thickness/length of the birefringent material layer 134 may be the retardance of the birefringent material layer 134. In one embodiment, the liquid crystal layer 122 may have a residual retardance as the electric field is applied to the liquid crystal layer 122 that may cause some of the light in the light beam 103 to rotate from the horizontal polarization state to a vertical or orthogonal polarization state. In one embodiment, the retardance of the retarder 132 may be approximately equal to a residual retardance of the LCOS microdisplay 116.

In one embodiment, the light source 102 may emit the light beam 103 having light that is horizontally polarized. The beam splitter 104 may pass the light beam 103 to the light engine 106. In this embodiment, the liquid crystal layer 122 may behave like a half-wave plate in double pass and rotate the polarization of the light beam 103 from the horizontal polarization state to a vertical or orthogonal polarization state so that on the return trip of the light beam 103 the beam splitter 104 may reflect the now vertically polarized light beam 107 through the lenses 108 and 110 to the screen 112 to create a white screen 112.

In an alternative embodiment, the light source 102 may emit the light beam 103 having light that is horizontally polarized, the beam splitter 104 may pass the horizontally polarized light to the light engine 106, an electrical field may be applied to the layer 123 resulting maintaining the horizontal polarization state of most of the light in the light beam 103 and rotating some of the light in the light beam 103 from the horizontal polarization state to a vertical or orthogonal polarization state so that on the return trip of the light beam 103 the beam splitter 104 may pass the horizontally polarized light in the light beam 103 to the lamp 102 and reflect the vertically polarized light in the light beam 103 to the screen 112 as the light beam 107.

In one embodiment, as the horizontally polarized light beam 103 propagates from the isotropic material layer 138 to the birefringent material layer 134 the reflected light beam may be decomposed into parallel 1× and orthogonal Iy polarization states. The parallel 1× and orthogonal ly polarization states may have the following relationships:
I_{X}=[nₜ₁ cos²θ₁+nₜ₂ sin² θ₁−n]²/(4n²) (1)
I_{Y}=(nₜ₂−nₜ₁)² sin² 2θ₁/(8n²) (2)
where nₜ₁ is the fast index of refraction of the birefringent material layer 134, nₜ₂ is the slow index of refraction of the birefringent material layer 134, n is the index of refraction of the isotropic material layer 136 and/or the isotropic material layer 138, θ₁ is the rotation of the birefringent layer 134 fast axis with respect to the incoming polarization state of the light beam 103, and the birefringence of the birefringent material layer 134 may be approximated by (nₜ₂−nₜ₁). In one embodiment, the fast index of refraction nₜ₁ of the birefringent material layer 134 may be approximately 1.5, the slow index of refraction nₜ₂ of the birefringent material layer 134 may be approximately 1.65, the birefringence (nₜ₂−nₜ₁) may be approximately 0.15, and the retardance L(nₜ₂−nₜ₁) may be approximately ten nanometers (10 nm). Equations (1) and (2) may describe the polarization state conversion that may occur at an interface between isotropic materials, such as the isotropic material layers 136 and/or 138, for example, and birefringent materials, such as the birefringent material layer 134, for example, according to embodiments of the present invention.

In one embodiment, the rotation of the fast axis with respect to the incoming polarization state of the light beam 103 θ₁ for the birefringent material layer 134 may be zero degrees (0°) and the light rotated to the orthogonal polarization state I_{Y} may be zero. In this embodiment, the top surface molecules 140 may be oriented in a direction parallel to the polarization of the incoming light beam 103 and the bottom surface molecules 142 may be oriented in a direction parallel to the polarization of the reflected light beam 103, as depicted in FIG. 4.

In an alternative embodiment, the rotation of the fast axis with respect to the incoming polarization state of the light beam 103 θ₁ for the birefringent material layer 134 may be ninety degrees (90°) and I_{Y} may be zero, with the top surface molecules 140 oriented in a direction parallel to the polarization of the incoming light beam 103 and the bottom surface molecules 142 oriented in a direction parallel to the polarization of the reflected light beam 103, as depicted in the twisted nematic cell in FIG. 4.

In one embodiment, light propagating through the bulk molecules 144 of the birefringent material layer 134 may also experience a rotation or polarization state change which when reflected off a surface may generate a component of light having an orthogonal polarization state. For example, as the horizontally polarized light beam 103 propagates through the birefringent material layer 134, reflected light having the orthogonal I_{Y} polarization state may be represented as follows:
I_{Y}=0.5 sin² 2θ₂(1−cos(δ))R_{X} (3)
where θ₂ is the average retardance angle that the light beam 103 sees as it travels through the birefringent material layer 134, δ is the phase retardance of the birefringent material layer 134 in double pass, and R_{X} is a reflection coefficient equal to I_{X}/I_{INPUT}, where I_{INPUT} is the intensity of the light in the light beam 103, that may normalize the reflected light I_{X} to the input light I_{INPUT}. In one embodiment, if the reflection coefficient R_{X} may be 0.02 (two percent), then the reflected light I_{X} may be 0.02 (two percent) of the input light I_{INPUT}. As the value of the reflection coefficient R_{X} is reduced, the amount of light rotated to the orthogonal polarization state I_{Y} may be reduced. In embodiments of the present invention, the reflection coefficient R_{X} of the top surface of the isotropic material layer 124 may be less than approximately 0.15 percent, the reflection coefficient R_{X} of the top surface of the isotropic material layer 136 may be less than approximately 0.15 percent, and the reflection coefficient R_{X} of the bottom surface of the isotropic material layer 136 may be less than approximately 0.15 percent. In an embodiment, the phase retardance 6 may be the birefringence of the birefringent material layer 134 multiplied times the thickness of the birefringent material layer 134 divided by the wavelength of the light beam 103.

In one embodiment, the thickness of the birefringent material layer 134 is such that reflections may be canceled. For example, the optical path length experienced by the light may be such that the birefringent material layer 134 may be an absentee layer such that the birefringent material layer 134 appears to exist in transmission but not in reflection. In this embodiment, the light beam 103 and the reflected light beam may meet out of phase (such as one hundred eighty degrees (180 degrees) out of phase with each other, for example) and cancel each other.

In one embodiment, if the orientation of the top surface molecules 140 is ninety degrees (90°) out of phase with the orientation of the bottom surface molecules 142, then the average retardance angle that the light beam 103 sees as it travels through the birefringent material layer 134 θ₂ may be approximately forty-five degrees (45°).

In one embodiment, the phase retardance of the birefringent material layer 134 in double pass δ may be a fixed value approximately equal to the residual retardance of the liquid crystal layer 122, such as, for example, ten nanometers (10 nm).

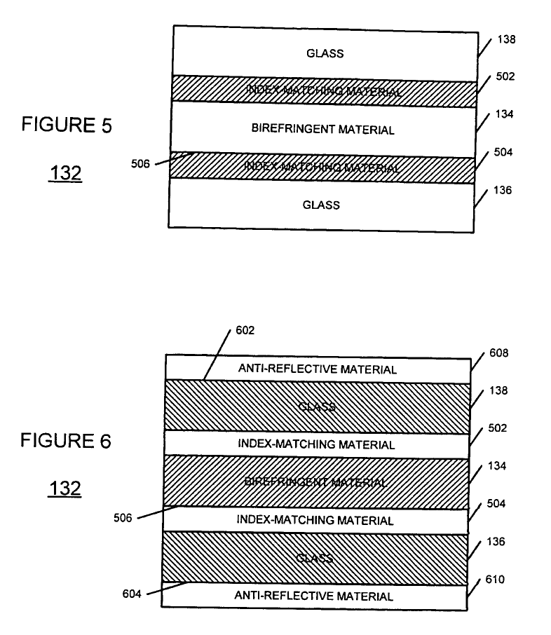

FIG. 5 is a cross sectional diagram of the retarder 132 according to an alternative embodiment in which a layer 502 of index of refraction matching material is disposed between the isotropic material layer 138 and the birefringent material layer 134. The index-matching layer 502 may have an index of refraction that index-matches the isotropic material layer 138 and the birefringent material layer 134. The illustrated retarder 132 also includes and a second layer 504 of index of refraction matching material disposed between the isotropic material layer 136 and the birefringent material layer 134 The index-matching layer 504 also may have an index of refraction that index-matches the isotropic material layer 136 and the birefringent material layer 134. In this embodiment, the reflection from a back surface 506 of the birefringent material layer 134 of light that is rotated, such as I_{Y}, for example, may be approximately zero percent (0%) and such reflected rotated light may be negligible.

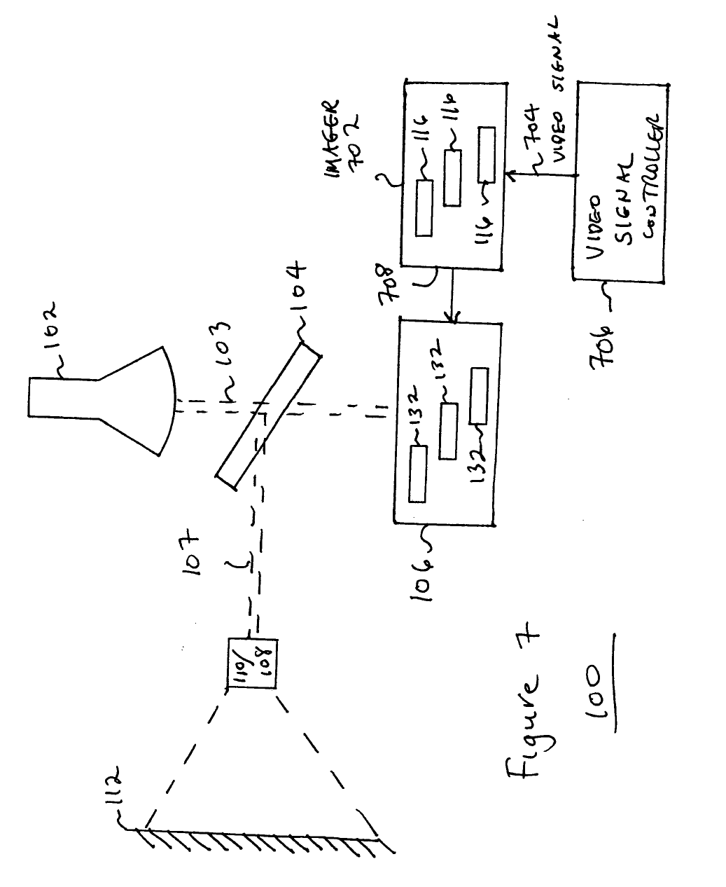

FIG. 6 is a cross sectional diagram of the retarder 132 according to an alternative embodiment in which a layer 608 of antireflective material is disposed on a top surface 602 of the isotropic material layer 138 and a second layer 610 of antireflective material is disposed on a bottom surface 604 of the isotropic material layer 136. In one embodiment, a top surface 602 of the isotropic layer 138 and a bottom surface 604 of the isotropic layer 136 may individually reflect light from the light beam 103. Some of this light may be light rotated to the orthogonal polarization state I_{Y}. In one embodiment, the antireflective material layers 602 and 604 may reduce light rotated to the orthogonal polarization state I_{Y} reflected off the isotropic layers 138 and 136, respectively.

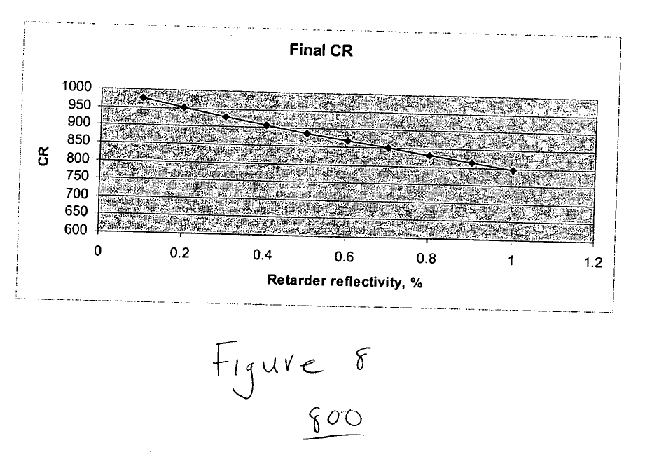

FIG. 7 is a high-level block diagram of the display system 100 according to an alternative embodiment of the present invention. In the illustrated embodiment, the display system 100 includes the lamp 102, optics 104, light engine 106, lenses 108 and 110, the screen 112, and an imager 702. The illustrated light engine 106 includes three retarders 132. The illustrated imager 702 includes three LCOS microdisplays or panels 116, which are associated with the three retarders.

The imager 702 may receive a video signal 704 as an input and may be controlled by a video signal controller 706.

In one embodiment, the display system 100 may have a contrast ratio (CR_{SYSTEM}), the retarder 132 may have a contrast ratio (CR_{RETARDER}), and the imager 702 may have a contrast ratio (CR_{IMAGER}). The relationship of the contrast ratios may be approximated as follows:
1/CR_{SYSTEM}=1/CR_{RETARDER}+1/CR_{IMAGER} (4)

In one embodiment of the present invention, the contrast ratio of the imager 702 CR_{IMAGER} may be 1000:1. In this embodiment, the effect of the reflection coefficient R_{X} of the back surface 506 of the retarder 132, and a front surface 708 of the imager 702 in one embodiment, is illustrated in FIG. 8, which is a graphical representation 800 of the contrast ratio of the display system 100 CR_{SYSTEM} that may be observed on the screen 112. In the illustrated embodiment, the graphical representation 800 includes an x-axis representing reflectivity of the retarder 132 in percent, which may be reflected light I_{X} as a percentage of the input light I_{INPUT}. The x-axis also may represent reflectivity of the front surface 708 of the imager 702. Also in the illustrated embodiment, the graphical representation 800 includes a y-axis representing the contrast ratio of the display system 100 CR_{SYSTEM}. As the graphical representation 800 illustrates, as the reflectivity of the retarder 132 increases, the contrast ratio of the display system 100 CR_{SYSTEM} decreases.

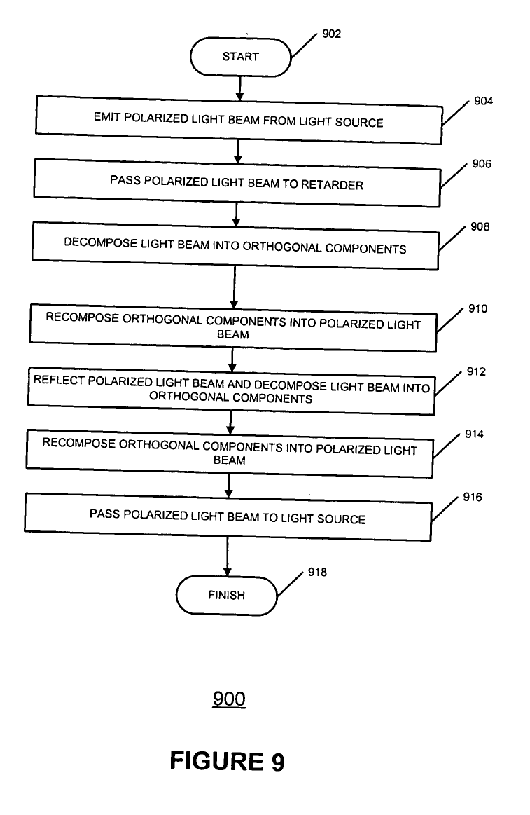

FIG. 9 is a flow chart illustrating a method 900 of operating the display system 100 according to an embodiment of the present invention. In the illustrated embodiment, the process 900 begins in a block 902, where control passes to a block 904.

In the block 904, the light source 102 may emit the light beam 103. In one embodiment, the light beam 103 may be substantially horizontally polarized.

In a block 906, the beam splitter 104 may pass the horizontally polarized light beam 103 through the antireflective material layer 608, through the isotropic material layer 138, and to the birefringent material layer 134.

In a block 908, the birefringent material layer 134 may decompose the horizontally polarized light beam 103 into I_{X} and I_{Y} and delay the phase of I_{Y} ninety degrees with respect to I_{X}.

In a block 910, I_{X} and I_{Y} may travel through the isotropic material layers 136 and 124 to the liquid crystal layer 122, which may delay I_{X} ninety degrees with respect to I_{Y} and recompose I_{X} and I_{Y} into the horizontally polarized light beam 103.

In a block 912, the pixelated reflective layer 118 may reflect the horizontally polarized light beam 103 back up through the liquid crystal layer 122, which may decompose the horizontally polarized light beam 103 into I_{X} and I_{Y} and delay I_{Y} ninety degrees with respect to I_{X}.

In a block 914, I_{X} and I_{Y} may travel through the isotropic material layers 136 and 124 to the birefringent material layer 134, which may recompose I_{X} and I_{Y} into the horizontally polarized light beam 103.

In a block 916, the horizontally polarized light beam 103 travels through the isotropic material layer 138, through the antireflective layer 608, through the beam splitter 104, to the lamp 102.

In a block 918, the process 900 finishes.

The operations of the process 900 have been described as multiple discrete blocks performed in turn in a manner that may be most helpful in understanding embodiments of the invention. However, the order in which they are described should not be construed to imply that these operations are necessarily order dependent or that the operations be performed in the order in which the blocks are presented. Of course, the process 900 is an example process and other processes may be used to implement embodiments of the present invention. A machine-accessible medium with machine-readable data thereon may be used to cause a machine, such as, for example, a processor to perform the method 900.

Embodiments of the present invention may be implemented using hardware, software, or a combination thereof. In implementations using software, the software may be stored on a machine-accessible medium.

A machine-accessible medium includes any mechanism that may be adapted to store and/or transmit information in a form accessible by a machine (e.g., a computer, network device, personal digital assistant, manufacturing tool, any device with a set of one or more processors, etc.). For example, a machine-accessible medium includes recordable and non-recordable media (e.g., read only memory (ROM), random access memory (RAM), magnetic disk storage media, optical storage media, flash memory devices, etc.), as recess as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “in one embodiment” or “in an embodiment” in various places throughout this specification does not necessarily mean that the phrases all refer to the same embodiment. The particular features, structures, or characteristics may be combined in any suitable manner in one or more embodiments.

The terms used in the following claims should not be construed to limit embodiments of the invention to the specific embodiments disclosed in the specification and the claims. Rather, the scope of embodiments of the invention is to be determined entirely by the following claims, which are to be construed in accordance with established doctrines of claim interpretation.

What is claimed is:

1. An apparatus, comprising:
a retarder having a double refracting material disposed between a first glass and a second glass, the double refracting material having a first surface layer of molecules having a first orientation and a second opposing surface layer of molecules having a second orientation, the first orientation being perpendicular to a first polarization state of a light beam to be incident on the retarder at the first surface layer of molecules, the second orientation being perpendicular to a second polarization state of a light beam at the second opposing surface layer of molecules.

2. The apparatus of claim 1, wherein the first orientation is parallel to the second orientation.

3. The apparatus of claim 1, wherein the first orientation is perpendicular to the second orientation.

4. The apparatus of claim 1, wherein the retarder comprises a ninety degree twisted nematic liquid crystal.

5. The apparatus of claim 1, wherein the retarder comprises a stressed polymer film, a stretched polymer film, and/or a liquid crystal cell.

6. An apparatus, comprising:
a first layer of isotropic material;
a second layer of isotropic material; and
a liquid crystal disposed between the first layer of isotropic material and the second layer of isotropic material, the liquid crystal having:
a first surface layer of molecules in contact with the first layer of isotropic material, the first surface layer of molecules of the liquid crystal being oriented perpendicular to a first polarization state of a light beam to be incident on the first surface layer of molecules of the liquid crystal.

7. The apparatus of claim 6, wherein the liquid crystal further comprises a second surface layer of molecules opposing the first surface layer of molecules, the second surface layer of molecules of the liquid crystal being in contact with the second layer of isotropic material, the second surface layer of molecules of the liquid crystal being perpendicular to a second polarization state of a light beam to be incident on the liquid crystal at the second surface layer of molecules of the liquid crystal.

8. The apparatus of claim 6, wherein the first layer of isotropic material includes a surface layer of molecules and the first surface layer of molecules of the liquid crystal is oriented perpendicular to the surface layer of molecules of the first layer of isotropic material.

9. The apparatus of claim 8, wherein the second layer of isotropic material includes a surface layer of molecules and the second surface layer of molecules of the liquid crystal is oriented perpendicular to the surface layer of molecules of the second layer of isotropic material.

10. The apparatus of claim 8, wherein the first layer of isotropic material includes a surface layer of molecules and the first surface layer of molecules of the liquid crystal is oriented parallel to the surface layer of molecules of the first layer of isotropic material.

11. The apparatus of claim 6, wherein the first layer of isotropic material includes a surface layer of molecules and the first surface layer of molecules of the liquid crystal is oriented parallel to the surface layer of molecules of the first layer of isotropic material.

12. The apparatus of claim 11, wherein the second layer of isotropic material includes a surface layer of molecules and the second surface layer of molecules of the liquid crystal is oriented parallel to the surface layer of molecules of the second layer of isotropic material.

13. The apparatus of claim 11, wherein the second layer of isotropic material includes a surface layer of molecules and the second surface layer of molecules of the liquid crystal is oriented perpendicular to the surface layer of molecules of the second layer of isotropic material.

14. An apparatus, comprising:
a birefringent material disposed between a first isotropic material and a second isotropic material, the birefringent material having a first index of refraction and a second index of refraction different from the first index of refraction;
a first index-matching material disposed between the first isotropic material and the birefringent material, the first index-matching material having a third index of refraction substantially index-matched to the first index of refraction; and
a second index-matching material disposed between the second isotropic material and the birefringent material, the second index-matching material having a fourth index of refraction substantially index-matched to the second index of refraction.

15. The apparatus of claim 14, wherein the birefringent material comprises a liquid crystal.

16. The apparatus of claim 15, wherein the first and/or the second isotropic material comprise a glass.

17. The apparatus of claim 14, wherein the birefringent material comprises birefringence substantially equal to a residual retardance of a predetermined liquid crystal on silicon cell.

18. The apparatus of claim 17, wherein the birefringent material comprises a fast axis oriented substantially ninety degrees relative to a fast axis of the residual retardance of the liquid crystal on silicon cell.

19. An apparatus, comprising:
a retarder comprising:
a double refracting material disposed between a first isotropic material and a second isotropic material;
a first antireflective material disposed on the first isotropic material; and
a second antireflective material disposed on the second isotropic material; and
a liquid crystal on silicon cell operationally coupled to the retarder.

20. The apparatus of claim 19, wherein the double refracting material comprises birefringence substantially equal to a residual retardance of a predetermined liquid crystal on silicon cell.

21. The apparatus of claim 20, wherein the double refracting material comprises a fast axis oriented substantially ninety degrees relative to a fast axis of the residual retardance of the liquid crystal on silicon cell.

22. The apparatus of claim 19, wherein the liquid crystal on silicon cell includes a having a reflection coefficient that is less than approximately 0.15 percent.

23. The apparatus of claim 22, wherein the first isotropic material includes a surface proximate to the liquid crystal on silicon cell, the surface of the first isotropic material proximate to the liquid crystal on silicon cell having a reflection coefficient that is less than approximately 0.15 percent.

24. The apparatus of claim 23, wherein the first isotropic material includes a surface opposing the liquid crystal on silicon cell and proximate to the double refracting material, the surface opposing the liquid crystal on silicon cell and proximate to the double refracting material having a reflection coefficient that is less than approximately 0.15 percent.

25. The apparatus of 19, wherein the double refracting material includes a thickness, the thickness to present an optical path length, the optical path length to cause light beam reflected from a front surface of the double refracting material and a light beam reflected from a back surface of the double refracting material to meet when the incident light beam is out of phase with the reflected light beam.

26. The apparatus of 25, wherein the thickness is to present an optical path length to cause the incident light beam to meet with the reflected light beam when the incident light beam is one hundred eighty degrees out of phase with the reflected light beam.

27. A system, comprising:
at least one liquid crystal on silicon panel;
at least one retarder operationally coupled to the liquid crystal on silicon panel, an individual retarder having birefringence substantially equal to a residual retardance of an individual liquid crystal on silicon panel, an individual retarder having a fast axis oriented substantially ninety degrees relative to a fast axis of the residual retardance of an individual liquid crystal on silicon panel; and
a lamp operationally coupled to the liquid crystal on silicon panel.

28. The system of claim 27, further comprising a polarizing beam splitter operationally coupled between the lamp and the retarder.

29. The system of claim 28, further comprising a narrow band polarizing beam splitter operationally coupled between the lamp and the retarder.

30. The system of claim 28, further comprising a broadband polarizing beam splitter operationally coupled between the lamp and the retarder.
